(19) United States
(12) Patent Application Publication
(10) Pub. No.: US 2020/0124416 A1
(43) Pub. Date: Apr. 23, 2020

(54) MONITORING METHOD, MONITORING SYSTEM AND INCLINOMETER DEVICE ASSOCIATED THEREWITH

(71) Applicant: SAFECERTIFIEDSTRUCTURE TECNOLOGIA S.P.A., Roma (IT)

(72) Inventors: Giuseppe MANCINI, TORINO (IT); Giannino SANDRIN, PORCIA (PN) (IT)

(73) Assignee: SAFECERTIFIEDSTRUCTURE TECNOLOGIA S.P.A., Roma (IT)

(21) Appl. No.: 16/624,600

(22) PCT Filed: Jun. 21, 2018
(86) PCT No.: PCT/IB2018/054592

§ 371 Date: Dec. 19, 2019

(30) Foreign Application Priority Data
Jun. 21, 2017 (IT) 102017000069350

(51) Int. Cl. G01C 9/02; E02D 1/00; E02D 33/00

(52) U.S. Cl. CPC G01C 9/02; E02D 33/00; E02D 1/00

(57) ABSTRACT

Inclinometer device (1), monitoring system (100) and method associated therewith for monitoring bonded elements comprising a flexible tape (2), at least one inclinometer (3) housed on or in the tape (2).

### TECHNICAL SCOPE

The invention relates to a monitoring method, a monitoring system and an inclinometer device associated therewith, of the type including the features mentioned in the precharacterising clause of the independent claims.

### TECHNOLOGICAL BACKGROUND

It is known that bonded elements of artificial structures (e.g. sections of bridges, house walls etc.) or bonded elements of a natural type (areas of ground, portions of water basins, portions of snowpacks etc.) can undergo displacement- and/or deformation-related rotation if subjected to movement or subsidence internally or of other structural portions or other areas of land (e.g. landslides, earthquakes, settlement etc.) with which they are directly or indirectly connected.

In particular, this movement or subsidence of land can arise unpredictably and very quickly, thus causing sometimes catastrophic damage to structures or areas of ground directly or indirectly affected by the aforesaid movement or subsidence.

It is obviously necessary, therefore, to be able to monitor as efficiently as possible any changes in the geological condition of land that is potentially subject to the aforesaid movement or subsidence and, in case of need, to have them updated promptly.

In this context of this requirement for information and monitoring, a relevant document is Chinese patent application CN 105973200, which describes a portable automated inclinometer for monitoring landslides comprising a sensor housed on a rigid slider that runs along a track of a tube inserted into ground to be investigated, a cable connected at one end to the sensor and at the other end to means for rewinding said cable and a system for processing the data collected.

When needed, an operator has to travel to the site where the tube has previously been provided, insert into it the aforesaid automated inclinometer and allow it to run slowly in a vertical direction relative to the ground, so as to collect the various items of information supplied by the sensor depending on the analysis depth at which the sensor is positioned.

This product is, however, unsuitable for continuously and efficiently monitoring bonded elements (in this specific case, areas of ground that may be subject to landslides).

In the first place, an obvious drawback inherent in products produced according to the teaching of the aforesaid Chinese patent is that there is no provision for inserting the inclinometer stably and definitively into the investigation tube. In fact, the rigid slider along which the sensor moves represents a very much smaller portion than the typical size of the investigation zone of the tubes inserted into ground potentially affected by landslides (generally between 100 and 200 metres long).

Obviously, during or following any landslides the tubes inserted into the ground being investigated may also suffer severe deformation following differential sliding of specific areas of ground of differing composition or behaviour. It is immediately obvious that in these cases the solution described by the aforesaid Chinese patent may prove inefficient, or even completely useless since there will be a risk of not managing either to thread the rigid slider into the tube or of being able to thread it into only a limited portion of the tube.

Another critical drawback is represented by the fact that, to be able to act promptly in the aforesaid case, the relevant data must be collected as quickly as possible. Clearly, the solution of the Chinese patent provides for the operator to travel to the site under investigation (which may be difficult to reach with ordinary vehicles), insert the rigid slider into the investigation tube (if, as previously discussed, this is still possible), collect the local data for the whole length of investigation tube, process the data and recover the slider from the tube.

These operations can cause operational delays quantifiable in terms of hours (in the most fortunate cases) or many days (in the least fortunate cases).

Furthermore, it should be considered that whenever the landslide has compromised access routes to the site concerned, the investigation cannot be carried out.

On the other hand, it is not possible to imagine an operator leaving a slider inside the tube because this could seriously compromise the functionality of the sensor during any subsequent movement or subsidence of the ground, and in any case would give such spatially limited local information as to prove practically useless for investigative purposes.

### DESCRIPTION OF THE INVENTION

The aim of the present invention is to provide a method for monitoring bonded elements and an inclinometer device associated therewith, overcoming one or more of the drawbacks of the prior art as identified.

In this context, the term bonded elements means parts of artificial structures (e.g. sections of bridges, house walls etc.) or natural structures (areas of ground, areas of water basins, portions of snowpacks etc.) which can undergo rotation, displacement and/or deformation if subjected to movement or subsidence of the land (e.g. landslides, earthquakes, settlement etc.) with which they are directly or indirectly connected.

Obviously, the aforesaid bonded elements refer to structures that are bonded rigidly to their surroundings and therefore do not enjoy a condition in which the whole bonded element can be translated freely, uniformly and consistently relative to the aforesaid surroundings. In that sense, when the aforesaid bonded elements are subjected to forces, they do not respond uniformly by simple displacement relative to existing rigid bonds, but by identifiable deformation, with local displacement or rotation.

Within this aim, one objective of the invention is to produce an inclinometer device that can be easily transported to the relevant site and easily installed in or on said site.

The teaching implemented according to the present invention is an inclinometer device for monitoring bonded elements comprising a flexible tape and at least one inclinometer housed on or in the flexible tape.

Preferably, the at least one inclinometer 3 is oriented in a direction perpendicular to a first longitudinal axis X.

The inclinometer device can thus be easily rolled up on itself, to increase its transportability, and can be unrolled only when the relevant site has been reached, for easy installation.

What is more, thanks to the aforesaid technical features, the aforesaid inclinometer device can be installed permanently in or on the relevant site, and left there so that it can supply—possibly constantly—up-to-date data on any displacement- and/or deformation- or subsidence-related rotation internally or of other structural sections or other areas of land to which they are directly or indirectly connected.

The aforesaid inclinometer device therefore lends itself to efficient application, for example, inside holes in ground in order to assess movement of areas thereof in the case of any landslides, on bridge spans in order to assess variations or structural subsidence following the passage of vehicles, wear or displacement of areas of land on the aforesaid directly or indirectly related structures, on ashlars of a tunnel (both longitudinally and transversely to the direction in which the tunnel extends) in order to assess the stability and resilience of the structure, on structural sections of dams, in this case also to assess any variations or structural subsidence that might be related to displacement or subsidence of areas of ground on the aforesaid directly or indirectly related structures, etc.

According to one embodiment, the at least one inclinometer is housed on or in the flexible tape, i.e. this means that the aforesaid inclinometer can be bonded to and supported on a surface of the tape or can be inserted inside the tape itself (e.g. the tape comprises two surfaces that wrap round or envelop the device, or the device is housed inside a cavity made in the aforesaid tape etc.).

Preferably, the inclinometer device comprises a plurality of inclinometers and the tape comprising a cable that operatively connects at least two inclinometers of the plurality of inclinometers.

The data collection capacity of the inclinometer device is therefore improved by inserting a plurality of inclinometers connected by a cable that allows both data transfer between the inclinometers and the flow of electrical current in order to supply the aforesaid inclinometers.

According to one embodiment, the inclinometer device comprises a processing unit that is operatively connected to the at least one inclinometer in order to process the data collected by the at least one inclinometer.

It is therefore possible to ensure that the data collected by the at least one inclinometer are processed at the relevant site itself, optimising processing periods and thereby reducing the time required for a user to access and/or exploit the aforesaid processed data.

Preferably, the processing unit is operatively connected to the at least one inclinometer by means of said cable at a second end of said tape that is opposite a first end.

This allows optimisation of both the utility and handling of the flexible tape during the steps of transport, installation and/or connection, and the accessibility of the processing unit for a user.

According to one embodiment, the plurality of inclinometers is spaced apart along a first longitudinal axis of said tape.

Better monitoring of the relevant site is thereby achieved, since the plurality of inclinometers is positioned at a known distance and optimised according to the phenomenon that is to be monitored.

Advantageously, the aforesaid spacing can be constant or variable along the aforesaid first longitudinal axis.

Preferably, the at least one inclinometer is housed inside a sealed box.

Thanks to this technical solution it is possible to leave the inclinometer device permanently bonded at the relevant site, still with the guarantee that the electrical and/or electronic components contained will not be damaged because of natural agents at the site (e.g. rain, wind, exposure to sunlight or frost, high relative humidity etc.).

According to one embodiment, the inclinometer device comprises a weighting device connected to the first end of the tape.

It therefore becomes easier to guide and completely unroll the tape, particularly when it is wished to orient it vertically and parallel to the directions of gravitational force (for example where it is wished to insert the device inside a substantially vertical hole).

Preferably, the at least one inclinometer is oriented in a direction perpendicular to the first longitudinal axis. More preferably, the longest dimension of the sealed box is parallel to the first longitudinal axis and the at least one inclinometer is oriented in a direction perpendicular to a medial plane of the sealed box.

This achieves the optimal orientation of at least one inclinometer for detecting any displacement or subsidence of the bonded elements.

According to one embodiment, the inclinometer device comprises a magnetometer capable of defining an initial orientation of at least one inclinometer and/or an accelerometer capable of detecting relative displacement.

This allows even more accurate reading of the variations in orientation of the inclinometers, starting from an initial known orientation. Furthermore, the presence of an accelerometer makes it possible to obtain increased amounts of information on displacement of the inclinometer or parts related thereto.

Preferably, the inclinometer device comprises at least one GPS and/or one humidity sensor and/or one temperature sensor.

This allows for further improvements of the information that can be obtained from the inclinometer device, since the GPS will make it possible to correlate inclinations as a function of specific spatial coordinates and therefore to find out which portion of structure under investigation is actually subject to rotation.

Furthermore, the presence of the GPS will allow identification of false negatives, which can arise in situations where the whole structure is displaced with a purely translational motion, with no significant local rotation arising.

Moreover, the presence of humidity and temperature sensors will allow monitoring of the conditions in which the data are read, and therefore correction of the conditions where necessary.

According to one embodiment, the inclinometer device comprises a sealed, protective heat-shrink tubing wrapped at least partly around the flexible tape and the at least one inclinometer.

This tubing allows the devices to be stored and transported more safely, preventing any unwanted elements from coming into contact with the electronic parts of the aforesaid device.

One embodiment of the present teaching according to the aforesaid invention involves a monitoring system that comprises an inclinometer device comprising a flexible tape, at least one inclinometer housed on or in said tape, the longest dimension of the tape being along a first longitudinal axis, with a width that is perpendicular to the first longitudinal axis, a tube having a second longitudinal axis, and comprising an opening shaped so as to allow the tape to slide freely inside the tube in the direction of the second longitudinal axis.

It is thus possible to further optimise the introduction of the monitoring system into a relevant site, for example by inserting the flexible tape into a tube previously positioned inside a hole made in ground under investigation.

Preferably, the opening has a substantially circular shape having a diameter greater than or equal to the width of the tape so as to allow the tape to slide freely inside the tube in the direction of the second longitudinal axis.

This facilitates and speeds up the actions of inserting the tape into the tube. According to one embodiment, the tape has a thickness and the tube comprises at least one slide guide for the tape extending along the second longitudinal axis, the slide guide being has a width greater than or equal to the thickness of the tape so as to allow guided sliding of the tape along the second longitudinal axis.

Preferably, the tape has a thickness, the tube comprises at least one slide guide for the tape extending along the second longitudinal axis, and the slide guide has a width greater than or equal to the thickness of the tape so as to allow guided sliding of the tape along the second longitudinal axis.

Preferably, the slide guide is defined either by grooves formed on an inner wall of the tube or by protrusions jutting out from the inner wall of the tube.

This allows the flexible tape to be bonded within the tube in directions perpendicular to the first longitudinal axis.

One embodiment of the present invention provides a method for monitoring bonded elements comprising making a hole in ground to be monitored, inserting an inclinometer device having the features previously described into the hole at a predefined height, non-removably bonding the inclinometer device in the hole, connecting a second end of the tape of the inclinometer device to a processing unit, measuring an initial orientation condition of the at least one inclinometer.

This allows the inclinometer device to be installed efficiently within the ground to be monitored. This type of installation means that useful data are constantly available, at the desired frequency, and therefore that both a trend in data over time and potentially critical unforeseen variations can be identified almost in real time. Furthermore, one embodiment of the aforesaid method involves non-removably bonding the inclinometer device in the hole by injecting grout into the hole.

It is thereby possible to bond the inclinometer device rigidly and securely to portions of the grout, which are in turn related to the rotation and/or displacement of areas of ground.

According to one embodiment, the method involves inserting a tube into the hole in the ground to be monitored, inserting an inclinometer device into the tube at a predefined height, non-removably bonding the inclinometer device in the hole by injecting grout into the tube, connecting a second end of the tape of the inclinometer device to a processing unit, measuring an orientation condition of the at least one inclinometer.

This makes the step of inserting the inclinometer device into the ground even more secure, because of the presence of a tube giving more stable definition to the internal cavity of the hole inside which the inclinometer device is to be inserted. According to one embodiment, the method comprises gradually extracting the tube from the hole during the step of injecting grout into the tube.

This results in savings in terms of material used and the grout is in direct contact with the areas of ground to be monitored.

Preferably, the method comprises measuring the orientation condition of the at least one inclinometer after a predetermined ageing period of the grout.

This makes it possible to monitor any inclinations that may develop following the process of ageing the grout.

According to one embodiment, the method comprises monitoring the progress of the orientation condition over time by means of a processing unit.

In this way the orientation condition can be monitored constantly and any significant variations in the expected or desired orientation can be rapidly detected.

### DESCRIPTION OF THE DRAWINGS

The features and advantages of the invention will be more clearly apparent from the detailed description of an exemplary embodiment, illustrated for information and non-restrictively, with reference to the appended drawings, in which:

FIG. 1 is a diagrammatic illustration of an inclinometer device for monitoring bonded elements,

FIG. 2 is a diagrammatic illustration of a monitoring system,

FIG. 3 is partial perspective view of a tube according to one embodiment,

FIG. 4 is partial perspective view of a tube according to another embodiment,

FIG. 5 is a diagrammatic illustration of a section of the tape comprised in the inclinometer device of FIG. 1 along a plane V,

FIG. 6 is a diagrammatic illustration of a section of the tape and a sealed box comprised in the inclinometer device of FIG. 1 along a plane VI,

FIG. 7 is a view from above of the tube according to one embodiment,

FIG. 8 is a view from above of the tube according to another embodiment,

FIG. 9 is a perspective view of a sealed box comprised in the present invention.

### DETAILED DESCRIPTION OF ONE EMBODIMENT

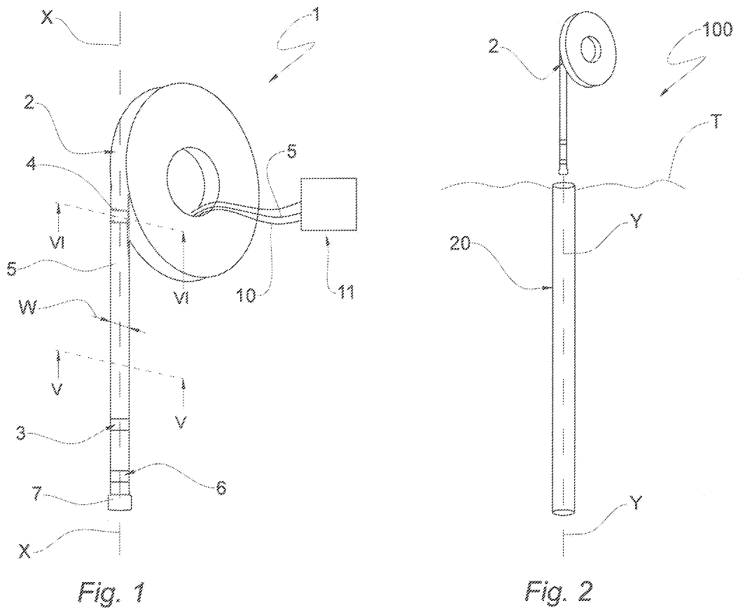

In FIG. 1, 1 represents an inclinometer device produced according to the present invention and designed to be installed in or on a relevant site according to the present method.

Preferably, the inclinometer device 1 for monitoring bonded elements comprises a flexible tape 2 and at least one inclinometer 3 housed on or in the tape 2.

Advantageously, the flexible tape 2 is made of polymeric material. In particular, the flexible tape 2 is made of polypropylene, polyethylene, or copolymers thereof, or similar polyolefins.

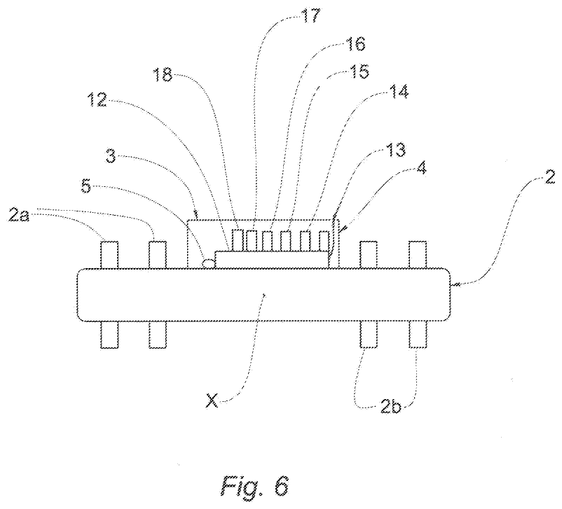

According to an embodiment shown in FIG. 6, the flexible tape 2 has ribs 2a, 2b jutting out from a central body, which give greater strength to the tape when it is subjected to torsional forces and also act as guides for any cables or wiring.

The flexible tape 2 can be produced in the lengths and thicknesses desired. Non-restrictive examples of installation of the aforesaid inclinometer device 1 may be:
installation on a bridge to be monitored in order to monitor any structural displacement/subsidence. In this case a particularly advantageous installation is produced by installing the aforesaid inclinometer device on lower sections of bridge spans so as not to interfere with the surfaces and spaces intended for the passage of vehicles. Furthermore, taking the example of a bridge with a plurality of spans, each with a typical length of about 30 m, it is possible to install a first inclinometer device with a length of, for example, 28 m, in the lower or side section of a first span, and a second inclinometer device, operatively connected to the first inclinometer device by connection means, also for example being about 28 m long, in the lower or side section of the second span, and to repeat this operation iteratively over the whole length of the bridge.
installation on a tunnel to be monitored in order to monitor any structural displacement/subsidence. In this case a particularly advantageous installation is produced by installing the aforesaid inclinometer device on upper sections of ashlars of the tunnel parallel and transverse to the direction in which said tunnel extends.
installation on a wall of a house to be monitored in order to monitor any structural displacement/subsidence. In this case a particularly advantageous installation is produced by installing the aforesaid inclinometer device on walls of the house, orienting the inclinometer device in a both vertical and transverse direction to the line of flooring of the building. This makes it possible also to detect rotation and/or displacement and/or subsidence of one plane relative to another (for example a lift shaft can be used to produce a rapid installation without leaving instrumentation exposed to view or close to where occupants pass by).
installation on an area of ground that may be subject to landslides and needs to be monitored in order to monitor any structural displacement/subsidence. In this case, a particularly advantageous installation is produced by installing the aforesaid inclinometer device inside a hole made in the ground to a depth of approximately 150-200 m, so that any rotation and/or displacement of areas of ground can be monitored.

These installations can preferably be produced by bonding the inclinometer device to the desired structural sections by fixing means such as resins and/or glues, nails, screws, rivets etc.

In particular, the flexible tape is a part that lends itself particularly effectively to housing portions of the aforesaid fixing means, given its length and toughness (even where there are through-holes) combined with plastic deformability and resistance to chemicals and harmful agents.

With reference to FIGS. 1, 5 and 6, the flexible tape 2 preferably has a slab-shaped form and its longest dimension L is oriented along a first longitudinal axis X, with a width W that is perpendicular to the first longitudinal axis X.

Advantageously, the longest dimension L (also known as length) is between 10 and 500 m.

Advantageously, the width W can be approximately two inches or four inches.

The inclinometer 3 can advantageously be of the single-, dual- or triple-axis type depending on the rotation that it is intended to detect and the required accuracy in the specific installations.

According to one embodiment, the inclinometer device 1 comprises a plurality of inclinometers 3, and the tape 2 comprises a cable 5 that operatively connects at least two inclinometers of the plurality of inclinometers 3.

Advantageously, the cable 5 comprises a plurality of metal wires, arranged so as to transfer information and/or electrical power supply between the at least two inclinometers, and a polymer tubing suitable for protecting the aforesaid metal wires from external agents. Alternatively, for example, the data can be transferred between the at least two inclinometers by means of optical fibres.

Preferably, the inclinometer device 1 comprising a processing unit 11 that is operatively connected to the at least one inclinometer 3 in order to process the data collected by the latter.

The processing unit is a CPU (e.g. processor, server, etc.) capable of recognising data supplied from at least one inclinometer, processing them and transferring them by suitable data transfer means to other processing units. Preferably, the CPU is operatively connected to a data bus so that more than one inclinometer can be connected thereto and so that each one is connected in parallel in order not to compromise the functionality of the inclinometer device if one inclinometer should be damaged.

Advantageously, the data transfer means are designed so as to carry out transfers via WiFi, Bluetooth, cloud etc. systems.

According to one embodiment, the processing unit 11 is operatively connected to at least one inclinometer 3 by means of the cable 5 at a second end 10 of the tape 2 that is opposite a first end 6.

Preferably, the plurality of inclinometers 3 are spaced apart along a first longitudinal axis X of said tape 2.

This spacing can, for example, be between 30 and 500 cm. Furthermore, the aforesaid spacing is not necessarily always uniform over the whole length of the aforesaid tape, but can vary in different portions of said tape.

With reference to an example cited previously, inclinometer devices installed in a tunnel can, advantageously, have a different spacing when the device is installed longitudinally along the tunnel (for example, a spacing of 500 cm over a maximum length of the inclinometer device of 500 m) compared with the spacing of the inclinometer devices installed transversely to the longitudinal axis of said tunnel (for example, a spacing of 200 cm over a maximum length of the inclinometer device of 50 m).

According to one embodiment, the at least one inclinometer 3 is housed inside a sealed box 4.

According to one embodiment, the inclinometer device 1 comprises a sealed box 4 including a seat 13.

Advantageously, the seat 13 is shaped so as to house the at least one inclinometer 3 in a direction perpendicular to the first longitudinal axis X.

According to one embodiment, the seat 13 is a PCB card.

With reference to FIGS. 1 and 6, the sealed box 4 is able to protect the electronic components that it contains from external agents.

Preferably, the sealed box 4 is made of polymeric material, more preferably of polycarbonate or other gainfully polymeric material additivated, or composite material having polymeric matrix.

According to one embodiment, the sealed box 4 is produced in 10% glass-fiber reinforced polycarbonate.

Advantageously, the polymeric material of said sealed box 4 is mixed with additives consisting of agents capable of protecting the aforesaid material of the sealed box 4 from UV radiation.

According to one embodiment, the sealed polycarbonate box 4 is preferably made in two parts that are joined together at the desired moment by a radio-frequency vibrowelding technique.

Preferably, said sealed box 4 is coated by a over-injected rubber, at least in its proximity and corresponding to the connection with the cable.

Said over-injected rubber is adapted to produce a chemical reaction with the box material and/or with the cable material in such a way to bond themselves in an unique body guarantying in such a way a even better sealing behaviour. Thanks to this technical solution, the sealed box 4 is usable in contact water conditions in which the pressure is up to 10 bar.

With reference to FIG. 8, the sealed box 4 is substantially parallelepipedal in shape and has smooth, flat outer surfaces (i.e. surfaces that are substantially parallel to the plane P identified by the first longitudinal X and the one parallel to the aforesaid width W).

Advantageously, the aforesaid plane, smooth surfaces are very efficient in the case where it is wished to bond the inclinometer device 1 to the site to be monitored using glue: in fact, the glue can be positioned on an unobstructed surface of the sealed box 4 and put in contact with the surface to which it is intended to adhere. In this way the sealed box 4 containing the at least one inclinometer will be positioned on and bonded directly to the structure to be monitored and the gluing points will be reduced to just those parts that actually most need such bonding. Preferably, the inclinometer device 1 comprising a weighting device 7 connected to the first end 6 of the tape 2.

With reference to FIG. 1, this weighting device 7 is a weight preferably trapezoidal, parallelepipedal, prismatic or similar in shape, capable of facilitating the orientation of the flexible tape 2 of the inclinometer device 1 particularly when unrolled vertically.

According to an embodiment, a box 4 is considered comprising a wall having a thickness lower than other walls ones and thus having higher deformability.

Gainfully, in this case a pressure sensor adapted to detect a pressure induced by the outer water acting on the box 4 is housed within said box having higher deformability.

Gainfully, said box 4 having higher deformability wall is the one placed nearby said weighting device 7.

According to one embodiment, the at least one inclinometer 3 is oriented in a direction perpendicular to the first longitudinal axis X.

Preferably, the inclinometer device 1 comprises a magnetometer 14 capable of defining an initial orientation of the at least one inclinometer 3 and/or an accelerometer 15 for detecting relative displacement of the at least one inclinometer 3 relative to the first longitudinal axis X.

The aforesaid magnetometers and accelerometers can be easily identified by persons skilled in the art according to specific need.

Advantageously, and particularly in the case of applications for bridges and tunnels, the inclinometer device 1 comprises a microphone that can record the sounds produced by passing vehicles: this means it will be possible also to assess possible deterioration of sections of the structures and road surfaces under investigation as a function of the variation in frequency of the sound produced by the passage of vehicles.

According to one embodiment, the inclinometer device 1 comprises at least one GPS (or GNSS) 16 and/or one humidity sensor 17 and/or a temperature sensor 18. The aforesaid GPS devices, humidity sensor 17 and temperature sensor 18 can be easily identified by persons skilled in the art depending on specific need.

Preferably, it is considered according to an embodiment, an head electric power center substantially placed at ground surface level and comprising a precision GNSS, preferably GPS, advantageously in RTK (Real Time Kinematics) version. Thanks to this technical solution it is possible to highlight and correct an possible drift of the displacements red by the clinometers and/or accelerometers and/or GPS placed in lower levels boxes in the ground thanks to the correct precise position knowledge of the head electric power center with precision lower than 1 mm. Advantageously, a Lora communication with the head electric power center is foreseen.

Preferably, the inclinometer device 1 comprises a sealed, protective heat-shrink tubing 19 wrapped at least partly around the flexible tape 2 and the at least one inclinometer 3.

This heat-shrink tubing is advantageously made of polymeric material. In particular, use is made of a heat-shrink tubing having a shrink temperature that is no higher than ambient temperature than is essential, so that when the heat shrinkage process is carried out it causes the least possible heat damage to the components close to it.

According to one embodiment of the present invention, a monitoring system 100 for bonded elements comprises an inclinometer device 1 comprising a flexible tape 2, at least one inclinometer 3 housed on or in the tape 2, the longest dimension L of the tape 2 being along a first longitudinal axis X, with a width W that is perpendicular to said first longitudinal axis X, a tube 20 having a second longitudinal axis Y, and comprising an opening 21 shaped so as to allow the tape 2 to slide freely inside the tube 20 in the direction of the second longitudinal axis Y. Advantageously, the tube 20 is made of metal or polymeric material.

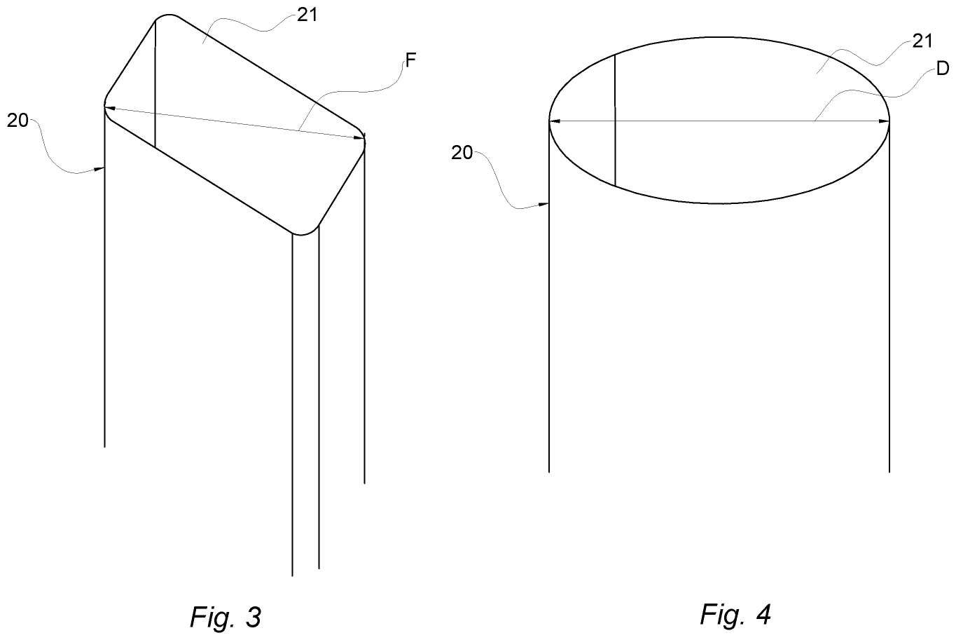

With reference to FIGS. 3 and 4, these identify respectively various exemplary embodiments of the tube 20 having an opening 21 with a form or section that is rectangular with connected angles, and circular.

Preferably, the monitoring system 100 in which the opening 21 has a substantially circular shape having a diameter D and the diameter D being greater than or equal to the width W of the tape 2 so as to allow the tape 2 to slide freely inside the tube 20 in the direction of the second longitudinal axis Y. Alternatively, the opening 21 is substantially rectangular in shape and has a maximum aperture F greater than or equal to the width W of the flexible tape 2.

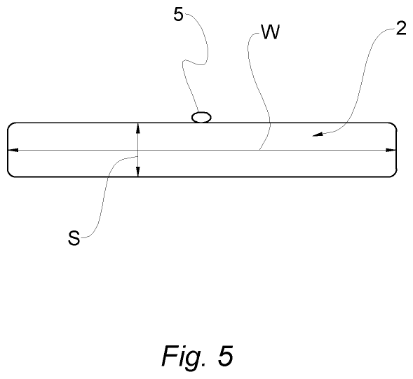

According to one embodiment and with reference to FIG. 5, the tape 2 has a thickness S and the tube 20 comprises at least one slide guide 22 for the tape 2 extending along the second longitudinal axis Y, the slide guide 22 has a width greater than or equal to the thickness S of the tape 2 so as to allow guided sliding of the tape 2 along the second longitudinal axis Y.

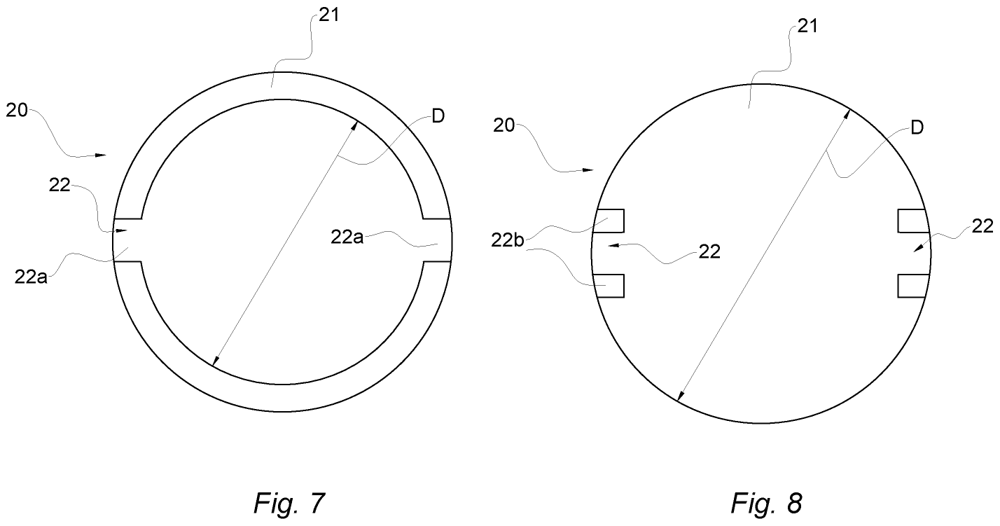

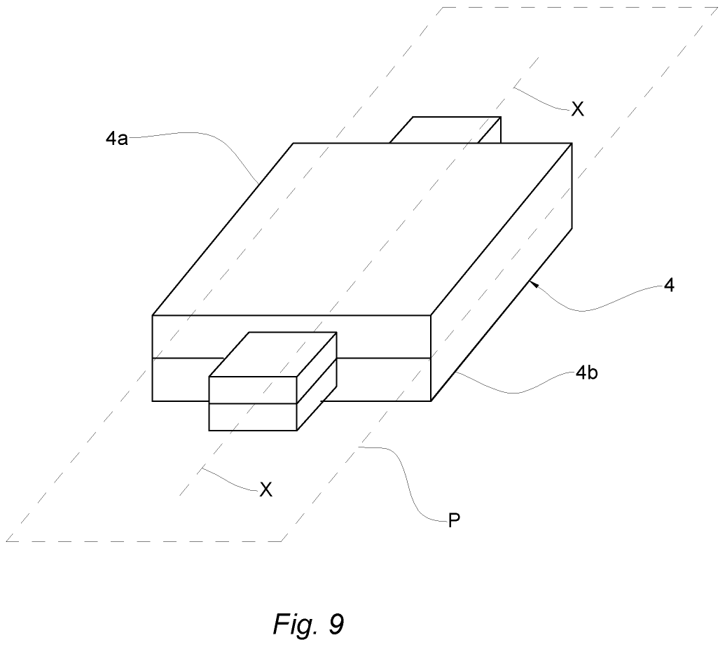

Preferably and with reference to FIG. 7 or 8, the slide guide 22 is defined by grooves 22a formed on an inner wall of said tube 20 or by protrusions 22b jutting out from said inner wall of said tube 20.

These grooves 22a or protrusions 22b can advantageously be produced during the steps of producing the tube 20.

According to one embodiment, the procedures for installing the aforesaid inclinometer device, defining the method for monitoring bonded elements according to the teaching of the present invention, comprise the steps described below: making a hole in ground to be monitored T, inserting an inclinometer device 1 having the features previously described into the hole at a predefined height, non-removably bonding the inclinometer device 1 in the hole, connecting a second end 10 of the tape 2 of the inclinometer device 1 to a processing unit 11, measuring an orientation condition O of the at least one inclinometer 3.

Advantageously, a magnetometer 14 comprised in the inclinometer device 1 is used for defining the alignment condition of the at least one inclinometer.

Advantageously, the inclinometer device 1 comprises a triple-axis inclinometer with a magnetometer and a thermometer, capable of supplying reliable, calibrated values of the absolute rotation (in space) of the measuring point as well as values of acceleration from any cause induced on the instrument (P- and S-waves). This means that the flexible tape 2 adapts perfectly to any deformation of the medium in (or on) which the inclinometer 3 has to be positioned, used as a support for the cables connecting the various sensors and for transmitting the measurements externally for almost immediate interpretation of the phenomena measured. Preferably, the aforesaid method involves non-removably bonding the inclinometer device 1 in the hole by injecting grout into the hole.

Advantageously, the grout is injected into the hole with pressure slightly above atmospheric pressure by means of a tube, and injection starts from the bottom of the hole moving towards the upper opening of said hole.

According to one embodiment, the method comprises inserting a tube 20 into the hole in the ground T to be monitored, inserting an inclinometer device 1 into the tube 20 at a predefined height, non-removably bonding the inclinometer device 1 in the hole by injecting grout into the tube 20, measuring an orientation condition O of the at least one inclinometer 3.

In this case too, the grout is injected into the tube with pressure slightly above atmospheric pressure, and injection starts from the bottom of the hole and moves towards the upper opening of said hole.

The aforesaid operations can be performed with the instruments normally available in this sector of the art.

Preferably, the tube 20 is gradually extracted from the hole during the step of injecting grout into the tube 20. This preferably includes a step of injecting grout into the hole at the same time as, and pro rata to, the step of extracting the tube 20 from the aforesaid hole.

According to one embodiment, the method comprises measuring the orientation condition O of the at least one inclinometer 3 after a predetermined ageing period Tc of the grout.

Advantageously, the predetermined ageing period Tc of the grout is approximately one week.

Preferably, the method comprises monitoring the progress of the orientation condition O over time by means of the processing unit 11.

Thanks to the aforesaid method it will be possible to monitor the course of any variations in inclination of sections of structures under investigation in real time, without personnel having to be physically present at the site to be monitored.

1. Inclinometer device (1) for monitoring coupled elements, comprising
a flexible tape (2),
at least one inclinometer (3),
wherein said at least one inclinometer (3) is housed on or in said tape (2).

2. The inclinometer device (1) according to claim 1, comprising:
a plurality of inclinometers (3), wherein said tape (2) comprises a cable (5) that operatively connects at least two inclinometers of said plurality of inclinometers (3).

3. The inclinometer device (1) according to claim 1, further comprising
a processing unit (11) that is that is operatively connected to said at least one inclinometer (3) in order to process the data collected by said at least one inclinometer (3).

4. The inclinometer device (1) according to claim 3, wherein
said processing unit (11) is operatively connected to said at least one inclinometer (3) by means of said cable (5) at a second end (10) of said tape (2) that is opposite a first end (6).

5. The inclinometer device (1) according to claim 2, wherein
said plurality of inclinometers (3) are spaced apart along a first longitudinal axis (X) of said tape (2).

6. The inclinometer device (1) according to claim 1, wherein
said at least one inclinometer (3) is housed inside a sealed box (4).

7. The inclinometer device (1) according to claim 4, comprising
a weighting device (7) connected to said first end (6) of said tape (2).

8. The inclinometer device (1) according to claim 1 wherein
said at least one inclinometer (3) is oriented in a direction perpendicular to said first longitudinal axis (X).

9. The inclinometer device (1) according to claim 1, further comprising
a magnetometer (14) that can define an initial orientation of the at least one inclinometer (3) and/or an accelerometer (15) for detecting relative displacements of the at least one inclinometer (3) with respect to said first longitudinal axis (X).

10. The inclinometer device (1) according to claim 1, further comprising
at least one GPS (16) and/or one humidity sensor (17) and/or one temperature sensor (18).

11. The inclinometer device (1) according to claim 1, further comprising
a sealed, protective heat-shrink tubing (19) wrapped around at least partly of said flexible tape (2) and said at least one inclinometer (3).

12. Monitoring system (100) for coupled elements, comprising
an inclinometer device (1) comprising
a flexible tape (2),
at least one inclinometer (3) housed on or in said tape (2),
said tape (2) having a main extent (L) along a first longitudinal axis (X) and a width (W) that is perpendicular to said first longitudinal axis (X),
a tube (20) having a second longitudinal axis (Y) and comprising an opening (21) shaped so as to allow said tape (2) to slide freely inside said tube (20) in the direction of said second longitudinal axis (Y).

13. The monitoring system (100) according to claim 12, wherein
said opening (21) has a substantially circular shape having a diameter (D) and said diameter (D) being greater than or equal to said width (W) of said tape (2) so as to allow said tape (2) to slide freely inside said tube (20) in the direction of said second longitudinal axis (Y).

14. The monitoring system (100) according to claim 12, wherein
said tape (2) has a thickness (S),
said tube (20) comprises at least one slide guide (22) for said tape (2) extending along said second longitudinal axis (Y),
said slide guide (22) has a width greater than or equal to said thickness (S) of said tape (2) so as to allow guided sliding of said tape (2) along said second longitudinal axis (Y).

15. The monitoring system (100) according to claim 12, wherein
said slide guide (22) is defined by grooves (22a) formed on an inner wall of said tube (20) or by protrusions (22b) jutting out from said inner wall of said tube (20).

16. Method for monitoring coupled elements, comprising
making a hole in ground to be monitored (T),
inserting an inclinometer device (1) having the characteristics of claim 1 in said hole at a predefined height,
non-removably coupling said inclinometer device (1) in said hole,
connecting a second end (10) of said tape (2) of said inclinometer device (1) to a processing unit (11),
measuring an orientation condition (O) of said at least one inclinometer (3).

17. The method according to claim 16, wherein
the step that involves non-removably coupling said inclinometer device (1) in said hole is carried out by injecting grout into said hole.

18. The method according to claim 16, further comprising
inserting a tube (20) into said hole in said ground (T) to be monitored,
inserting an inclinometer device (1) in said tube (20) at a predefined height,
non-removably coupling said inclinometer device (1) in said hole by injecting grout into said tube (20),
measuring an orientation condition (O) of said at least one inclinometer (3).

19. The method according to claim 18, wherein
said tube (20) is gradually extracted from said hole during said step of injecting grout into said tube (20).

20. The method according to claim 16, further comprising
measuring said orientation condition (O) of said at least one inclinometer (3) after a predetermined ageing period (Tc) of said grout.

21. The method according to claim 16, further comprising
monitoring the progress of said orientation condition (O) over time by means of said processing unit (11).
